(19) United States
(12) Patent Application Publication
(10) Pub. No.: US 2024/0361007 A1
(43) Pub. Date: Oct. 31, 2024

(54) HOT WATER SUPPLY SYSTEM

(71) Applicant: NORITZ CORPORATION, HYOGO (JP)

(72) Inventors: Atsushi USHIO, AKASHI-SHI (JP); Shinichi OKAMOTO, Hyogo (JP)

(73) Assignee: NORITZ CORPORATION, HYOGO (JP)

(21) Appl. No.: 18/624,162

(22) Filed: Apr. 2, 2024

(30) Foreign Application Priority Data
Apr. 27, 2023 (JP) 2023-073113

(51) Int. Cl. F24D 19/10

(52) U.S. Cl. CPC F24D 19/1051; F24D 2220/04

(57) ABSTRACT

The hot water suppliers are configured to communicate with a hot water supplier on a downstream side via the communication line connected to a first communication connector, and communicate with a hot water supplier on an upstream side via the communication line connected to a second communication connector. In each of the first communication connector and the second communication connector, a shorting pin is connected together with the communication line by installation of a cable connector, thereby detecting connection of the communication line. When detecting that the communication line is connected to the first communication connector and the communication line is not connected to the second communication connector, a controller operates to perform a function of supervisory control for cooperative control of multiple hot water suppliers communicatively connected.

### CROSS-REFERENCE TO RELATED APPLICATION

This application claims the priority benefits of Japanese application no. 2023-073113, filed on Apr. 27, 2023. The entity of the above-mentioned patent application is hereby incorporated by reference herein and made a part of this s specification.

### BACKGROUND

### Technical Field

The disclosure relates to a hot water supply system, and more particularly to a connected hot water supply system including multiple hot water suppliers connected in parallel to a hot water outlet route.

### Related Art

A hot water supply system capable of handling outgoing of a large amount of hot water by including multiple hot water suppliers connected in parallel to a hot water outlet route is known.

For example, in Japanese Unexamined Patent Publication No. 2021-116977 (Patent Literature 1), it is described that a hot water supply system is configured by cooperative control of multiple hot water suppliers communicatively connected in series in string (daisy chained).

In the hot water supply system of Patent Literature 1, by installing a program for a supervisory control function of cooperative control in a controller of each hot water supplier, it is unnecessary to arrange a separate controller for supervisory control. That is, cooperative control is realized by the controller of one of the multiple hot water suppliers operating as a master controller by executing the program for the supervisory control function.

In Patent Literature 1, if a communication failure occurs in a serial communication connection, a group of hot water suppliers may lose communication with the current master controller. For this reason, a control processing for automatically deciding a new master controller in the group of hot water suppliers is executed in response to the detection of a communication interruption, and it is possible to avoid a decrease in the number of hot water suppliers compatible with cooperative control and prevent a decrease in the hot water supply capacity of the entire hot water supply system.

### CITATION LIST

### Patent Literature

[Patent Literature 1] JP2021-116977A

According to the hot water supply system of Patent Literature 1, in each hot water supplier, when regular communication is cut off, communication interruption with a master controller is detected and a control processing is activated to automatically decide a new master controller among a group of hot water suppliers whose communication with the current master controller has been interrupted. In this case, from the viewpoint of preventing false detection, it is common to establish the detection of communication interruption on the condition that the above-mentioned periodic interruption of communication has continued for a certain period of time.

Thus, in the hot water supply system of Patent Literature 1, in a case where a communication line of one hot water supplier is removed for inspection or repair, the group of hot water suppliers on the downstream side needs to wait for the above-mentioned certain period of time before determining the detection of communication interruption with the main controller. As a result, there is concern that hot water cannot be supplied temporarily from these downstream group of hot water suppliers, and the hot water supply capacity of the hot water supply system may be temporarily reduced (for example, for about a few minutes).

The disclosure has been made to solve these problems, and an object of the disclosure is to realize cooperative control that automatically and promptly responds to removal of a communication line in a hot water supply system in which multiple hot water suppliers are communicatively connected in series using communication lines.

### SUMMARY

In one aspect of the disclosure, a hot water supplier system is configured. The hot water supplier system includes multiple hot water suppliers connected in parallel to a common hot water outlet route. Each of the multiple hot water suppliers includes a first connector and a second connector connectable to a communication line and a short circuit terminal; a first communication circuit; a second communication circuit; a first detection circuit; a second detection circuit; and a controller that controls operation of the hot water supplier. The first communication circuit communicates with another hot water supplier via the communication line connected to the first connector. The second communication circuit communicates with another hot water supplier via the communication line connected to the second connector. The first detection circuit detects whether or not the communication line is connected to the first connector based on whether or not the short circuit terminal is connected to the first connector. The second detection circuit detects whether or not the communication line is connected to the second connector based on whether or not the short circuit terminal is connected to the second connector. The controller of each of the hot water suppliers is configured in advance to have a supervisory control function for cooperatively operating a group of hot water suppliers communicatively connected in series via communication line. Between adjacent hot water suppliers in a series connection constituting the communication connection, the first communication circuit of a hot water supplier on an upstream side, which is one predetermined end side of the series connection, and the second communication circuit of a hot water supplier on a downstream side, which is the other end side of the series connection, in the group of hot water suppliers are communicatively connected sequentially. Each of the controllers recognizes that the controller is a leader controller that operates to perform the supervisory control when it is detected by the first detection circuit that the communication line is connected to the first connector and it is detected by the second detection circuit that the communication line is not connected to the second connector.

### BRIEF DESCRIPTION OF THE DRAWINGS

FIG. 1 is a schematic diagram illustrating configuration of a hot water supply system according to the embodiment.

FIG. 2 is a schematic diagram illustrating a configuration example of each hot water supplier shown in FIG. 1.

FIG. 3 is a first diagram illustrating cooperative control in the hot water supply system shown in FIG. 1.

FIG. 4 is a second diagram illustrating cooperative control in the hot water supply system shown in FIG. 1.

FIG. 5 is a schematic diagram illustrating a configuration example for detecting whether or not a communication line is connected to a communication connector in each hot water supplier.

FIG. 6 is a flowchart illustrating a control processing for deciding role allocation of cooperative control in the hot water supply system according to an embodiment.

FIG. 7 is a conceptual diagram illustrating a result of deciding the allocation of cooperative control when the control processing according to the flowchart of FIG. 6 is applied to the configuration example of FIG. 1.

FIG. 8 is a schematic diagram illustrating a comparative example of cooperative control processing when one hot water supplier is temporarily not used.

FIG. 9 is a schematic diagram illustrating cooperative control processing when one hot water supplier is temporarily not used in the hot water supply system according to the embodiment.

FIG. 10 is a schematic diagram illustrating the state inside the hot water supplier with a communication line removed from the connector in FIG. 9.

### DESCRIPTION OF THE EMBODIMENTS

According to the disclosure, in a hot water supply system in which multiple hot water suppliers are communicatively connected in series by communication lines, it is possible to realize cooperative control that automatically and promptly responds to removal of the communication lines.

Embodiments of the disclosure will be described in detail below with reference to the drawings. Moreover, hereinafter, the same or corresponding parts in the figures will be denoted by the same reference numerals, and the description thereof will not be repeated in principle.

### (Configuration of Hot Water Supply System)

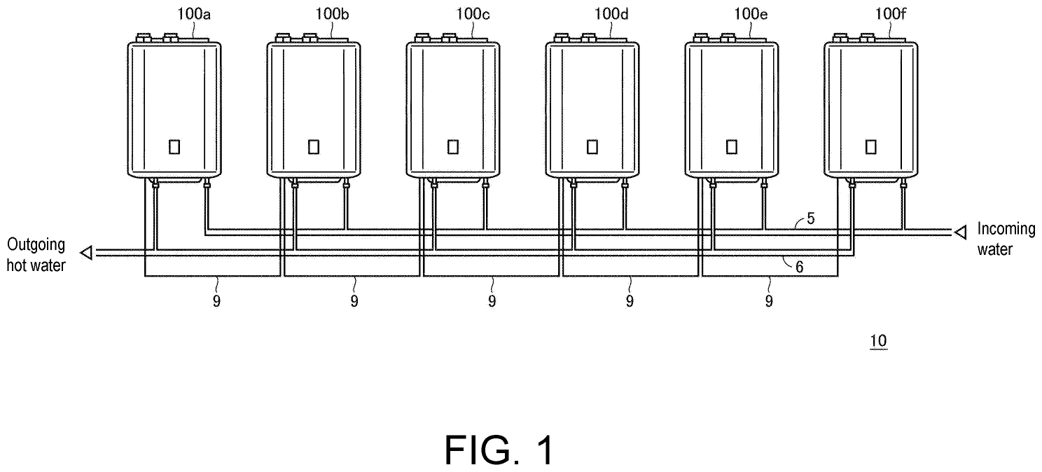

FIG. 1 is a schematic diagram illustrating configuration of a hot water supply system 10 according to the embodiment.

Referring to FIG. 1, the hot water supply system 10 according to the embodiment includes a water inlet route 5, a hot water outlet route 6, and multiple hot water suppliers 100a to 100f connected in parallel to the hot water outlet route 6. The hot water suppliers 100a to 100f are respectively communicatively connected in series by a communication line 9 between adjacent hot water suppliers in the connection sequence, so as to be connected in a string (daisy chain). Moreover, in FIG. 1, multiple communication lines 9 are indicated by the same reference numeral, but each communication line 9 connects one hot water supplier 100 to another hot water supplier 100 on a one-to-one basis, and in this embodiment, and in this embodiment, it is confirmatively described that no same communication line connecting multiple hot water suppliers 100 is configured. In a series connection constituting a communication connection, one predetermined end side is defined as the “upstream side,” and the other end side is predefined as the “downstream side.”

Hereinafter, in the embodiment, the hot water supply system 10 is composed of six hot water suppliers 100a to 100f, but the number of hot water suppliers 100 connected in parallel that constitute the hot water supply system 10 is arbitrary. Further, the following descriptions that distinguish the six hot water suppliers are to indicate each element with subscripts a to f, whereas the descriptions common to the six hot water suppliers are to indicate each element without the subscripts a to f.

In the example of FIG. 1, the hot water suppliers 100a to 100f are also connected in parallel with the water inlet route 5, but in the hot water supply system 10, the water inlet route 5 may not need to be completely common among the hot water suppliers 100a to 100f.

In the following, with respect to the hot water suppliers 100a to 100f arranged in order, the hot water supplier 100a side (left side in the drawing) is the upstream side, and the hot water supplier 100f side (the right side in the drawing) is the downstream side. The communication connection will also be described assuming that a communication connection in series is formed such that the hot water supplier 100a is the most upstream and the hot water supplier 100f is the most downstream by connecting adjacent hot water suppliers in a natural manner with each communication line 9. Moreover, it is confirmatively described that the upstream and downstream in the communication connection are decided not by the arrangement position of each hot water supplier but by the order of series connection by the communication line 9.

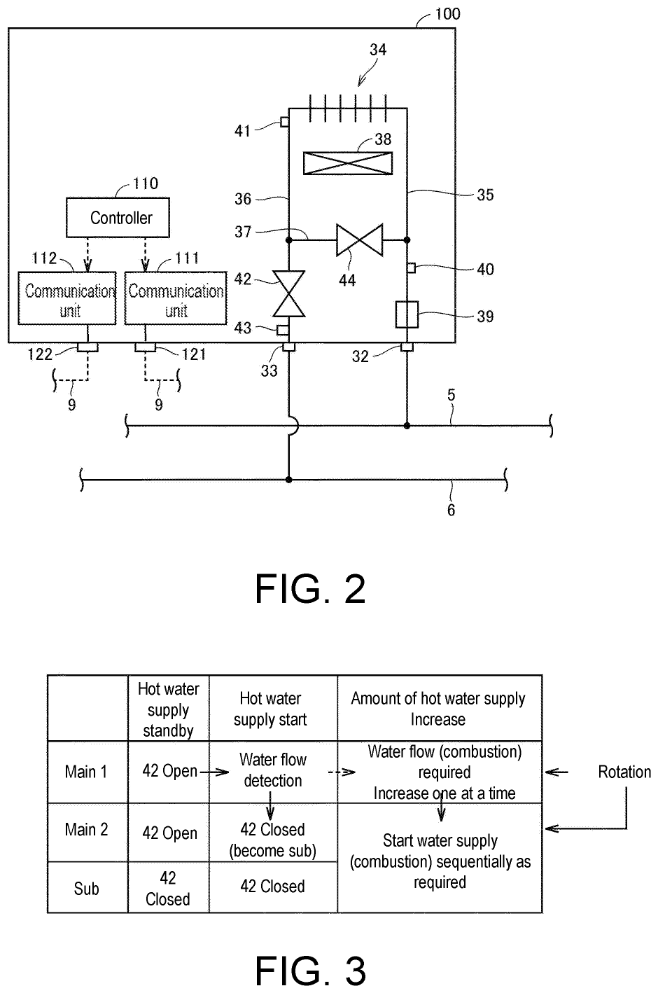

FIG. 2 shows a configuration example of the hot water supplier 100.

Referring to FIG. 2, hot water supplier 100 includes a water inlet port 32 connected to the water inlet route 5; a hot water outlet port 33 connected to the hot water outlet route 6, a heat exchanger 34, a water inlet passage 35, a hot water outlet passage 36, a bypass passage 37, a combustion burner 38, a flow rate adjustment valve 42, a controller 110, the first communication circuit 111, the second communication circuit 112, a first communication connector 121, and a second communication connector 122.

The water inlet passage 35 guides low-temperature water from the water inlet port 32 to the heat exchanger 34. The combustion burner 38 generates combustion heat of fuel (typically gas) when operating (combustion is ON). The heat exchanger 34 uses the amount of heat generated by the combustion burner 38 to heat the low-temperature water flowing through the heat exchanger 34. The hot water outlet passage 36 guides the heated high-temperature water that has passed through the heat exchanger 34 to the hot water outlet port 33. The combustion burner 38 and the heat exchanger 34 constitute a “heating mechanism.”

The bypass passage 37 bypasses the heat exchanger 34 and guides the low-temperature water directly to the hot water outlet passage 36. The hot water outlet port 33 outputs hot water at an appropriate temperature, which is a mixture of the high-temperature water from the heat exchanger 34 and the low-temperature water that has passed through the bypass passage 37. A bypass flow rate adjustment valve 44 is inserted and connected to the bypass passage 37, and by adjusting the opening degree of the bypass flow rate adjustment valve 44, the mixing ratio of high-temperature water and low-temperature water in the hot water outlet passage 36 may be controlled.

The water inlet passage 35 is provided with a flow rate sensor 39 for detecting the incoming water flow rate in response to a hot water supply request (for example, opening of a hot water tap (not shown)), and an incoming water temperature sensor 40 for detecting the incoming water temperature. Further, the hot water outlet passage 36 is provided with a can body temperature sensor 41 and an outgoing hot water temperature sensor 43. The can body temperature sensor 41 is disposed on the upstream side (on the heat exchanger 34 side) of a merging position with the bypass passage 37 and detects the temperature of the high-temperature water output from the heat exchanger 34. The outgoing hot water temperature sensor 43 is disposed on the downstream side (on the hot water outlet port 33 side) of the merging position, and detects the temperature of hot water outgoing from the hot water outlet port 33.

The flow rate adjustment valve 42 for adjusting the flow rate of outgoing hot water is inserted and connected on the downstream side of a merging position of the hot water outlet passage 36. The flow rate adjustment valve 42 has a function of controlling the opening degree to be fully closed (flow rate=0). That is, the flow rate adjustment valve 42 may adjust the hot water supply flow rate of the hot water supplier 100 from Q=0 to Q=Qmax (flow rate at maximum opening degree).

The controller 110 is typically configured by a microcomputer. The controller 110 controls each element of hot water supplier 100 using the detected values of each sensor described above. In the example of FIG. 2, the controller 110 may control the opening degrees of the flow rate adjustment valve 42 and the bypass flow rate adjustment valve 44, as well as the combustion ON/OFF of the combustion burner 38 and the amount of heat generated.

When the controller 110 detects that a passing flow rate through the “heating mechanism” has reached or exceeded a predetermined minimum operating flow rate (MOQ) based on the detected value of the flow rate sensor 39 (hereinafter also referred to as “water flow ON”), it starts hot water supply by starting combustion (i.e. operation of the heating mechanism) in the combustion burner 38. At this time, the passing flow rate of the heating mechanism may be calculated using the detected value of the flow rate sensor 39 (incoming water flow rate, i.e. hot water supply flow rate) and the mixing ratio based on the opening degree of the bypass flow rate adjustment valve 44. Thus, when the flow rate adjustment valve 42 is fully closed, the hot water supplier 100 does not execute hot water supply because the incoming water flow rate does not exceed the MOQ.

Moreover, the flow rate sensor 39 may also be arranged on the downstream side of a connection point with the bypass passage 37. In this case, the detected value of the flow rate sensor 39 may be used, without change, to detect “water flow ON”, and the above-mentioned mixing ratio may further be used to calculate the incoming water flow rate toward the hot water supplier 100, that is, the flow rate of hot water supply.

During hot water supply, the controller 110 executes hot water supply temperature control. For example, based on the detected values of the incoming water flow rate (flow rate sensor 39), incoming water temperature (incoming water temperature sensor 40), and outgoing hot water temperature (outgoing hot water temperature sensor 43), the amount of heat generated by the combustion burner 38, which depends on the amount of supplied fuel, and the mixing ratio, which depends on the opening degree of the bypass flow rate adjustment valve 44, are controlled such that the detected value of the outgoing hot water temperature matches of the outgoing hot water setting temperature.

Further, in the hot water supplier 100 configuring the hot water supply system 10, the controller 110 controls the flow rate using the flow rate adjustment valve 42. Specifically, each hot water supplier 100 is set to either standby mode or water flow mode by a control command from a leader controller, which will be described later, as part of cooperative control.

In the hot water supplier 100 in the water flow mode, the flow rate adjustment valve 42 is opened and basically set to the maximum opening degree corresponding to the maximum flow rate Qmax described above. On the other hand, in the hot water supplier 100 in standby mode, the flow rate adjustment valve 42 is controlled to be fully closed.

The first communication circuit 111 transmits and receives data to and from the second communication circuit 112 of another hot water supplier adjacent to the downstream side of the communication connection via the communication line 9 connected to the first communication connector 121. Similarly, the second communication circuit 112 transmits and receives data to and from the first communication circuit 111 of another hot water supplier adjacent to the upstream side of the communication connection via the communication line 9 connected to the second communication connector 122. The first communication circuit 111 and the second communication circuit 112 transmit and receive data by, for example, full-duplex serial communication.

In each hot water supplier 100, the first communication circuit 111, the first communication connector 121, the second communication circuit 112, and the second communication connector 122 may be mounted, for example, on a printed circuit board on which the controller 110 is mounted. Further, in FIG. 2, the controller 110, the first communication circuit 111, and the second communication circuit 112 are shown as separate elements, but in a case where the main part of the controller 110 is configured by a microcomputer, some function of each of the first communication circuit 111 and the second communication circuit 112 may be realized by the microcomputer.

### (Description of Cooperative Control)

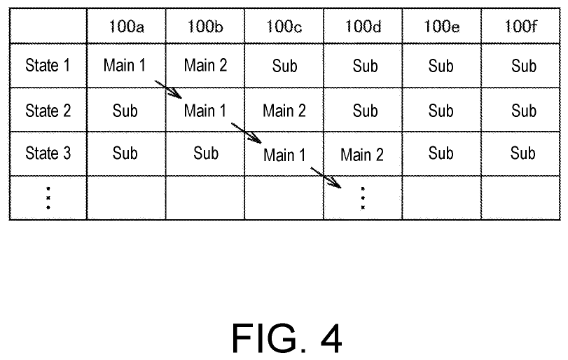

Next, cooperative control in the hot water supply system 10 will be described with reference to FIGS. 3 and 4.

As shown in FIG. 3, cooperative control is executed by classifying the hot water suppliers 100a to 100f into one “main 1 hot water supplier”, one or more “main 2 hot water suppliers”, and other “sub hot water suppliers.” When the hot water supply system 10 is on standby for hot water supply, each of the sub hot water suppliers is set to standby mode and the flow rate adjustment valve 42 (FIG. 2) is closed. On the other hand, each of the main 1 hot water supplier and the main 2 hot water supplier is set to water flow mode, and the flow rate adjustment valve 42 (FIG. 2) is opened.

When the hot water supply system 10 starts supplying hot water, water flow is not detected in each of the sub hot water suppliers in which the flow rate adjustment valve 42 is closed, and combustion is not started. On the other hand, in each of the main 1 hot water supplier and the main 2 hot water supplier in which the flow rate adjustment valve 42 is open, the flow rate sensor 39 detects water flow reaching or exceeding the MOQ.

When the main 1 hot water supplier starts combustion in response to detection of water flow, hot water supply to the hot water outlet passage 36 is started. Further, when the main 1 hot water supplier starts supplying hot water, it instructs the main 2 hot water supplier to convert to standby mode, that is, to close the flow rate adjustment valve 42. As a result, hot water supply may be started with the hot water supply capacity of one supplier (main 1 hot water supplier), compared to the case where flow rate adjustment valves 42 of all the hot water suppliers are opened during standby for hot water supply, the lower limit range of the flow rate capable of hot water supply may be expanded.

After that, if the hot water supply flow rate of the main 1 hot water supplier (the flow rate detected by the flow rate sensor 39 when the combustion is on) exceeds a predetermined first reference flow rate, a request to convert to the water flow mode is generated for the main 2 hot water supplier. When the flow rate adjustment valve 42 of the main 2 hot water supplier is opened, hot water is also supplied from the main 2 hot water supplier in response to the water flow being detected by the flow rate sensor 39, and hot water supply of the two hot water suppliers starts. Since the hot water suppliers 100a to 100f are connected in parallel, as long as the opening degrees of the flow rate adjustment valves 42 are the same, the flow rates (hot water supply flow rate) in the main 1 hot water supplier and the main 2 hot water supplier in this state are the same.

Thus, the main 2 hot water supplier is positioned as a backup for water flow detection. That is, upon detection of water flow ON, if the main 2 hot water supplier detects an abnormality of the main 1 hot water supplier if it does not receive a command from the main 1 hot water supplier to convert to standby mode after a certain period of time. In this case, the main 2 hot water supplier starts combustion in response to the detection of the abnormality, thereby starting to supply hot water to the hot water outlet passage 36. Further, the abnormality in the main 1 hot water supplier is transmitted to a leader controller (to be described later) that supervises cooperative control.

Moreover, in a case where two or more hot water suppliers in the hot water supply system 10 are performing hot water supply operation, the last hot water supplier that starts the hot water supply operation among the hot water suppliers performing the hot water supply operation operates to supply hot water as “for capacity adjustment” in which the hot water supply flow rate changes with the opening degree control of the flow control valve 42. On the other hand, the remaining hot water suppliers executes the hot water supply operation as “for capacity fix” in which the opening degree of the flow rate adjustment valve 42 is fixed such that the flow rate of hot water supply is fixed. In the hot water suppliers that operates to supply hot water supply for capacity adjustment, if the hot water supply flow rate exceeds the first reference flow rate, the hot water supplier becomes a hot water supplier for capacity fix, and one of the hot water suppliers in standby starts hot water supply operation as a new one for capacity adjustment. For example, the first reference flow rate is equivalent to the hot water supply flow rate by a hot water supplier for capacity fix. Thus, as an example, cooperative control of the multiple hot water suppliers 100a to 100f in response to an increase in hot water supply flow rate is realized by converting the hot water suppliers one by one from standby mode to water flow mode (for capacity adjustment) toward the downstream side.

Moreover, in the hot water suppliers that are operating to supply hot water for capacity adjustment, if the hot water supply flow rate falls below a second reference flow rate that is set lower than the first reference flow rate, the hot water supplier stops supplying hot water and converts to standby mode, and one of the hot water suppliers that had been operating at fixed capacity until then starts to perform hot water supply operation newly as a hot water supplier for capacity adjustment. Thus, as an example, cooperative control of the multiple hot water suppliers 100a to 100f in response to a decrease in the hot water supply flow rate is realized by a manner of converting the hot water suppliers one by one from the water flow mode (for capacity adjustment) to the standby mode toward the upstream side. Moreover, in the main 1 hot water supplier and the main 2 hot water supplier, even if the flow rate of the heating mechanism falls below the MOQ and water flow OFF is detected, combustion is turned off while the flow rate adjustment valve 42 is kept open.

According to the above cooperative control, during hot water supply operation, the main 1 hot water supplier supplies hot water preferentially, and then the main 2 hot water supplier preferentially supplies hot water. Thus, if the designation of the operation (combustion) start order corresponding to the increase in hot water supply flow rate as described in FIG. 3 is unchanged, there is a concern that the operating time (specifically, the combustion time) of some of the hot water suppliers 100a to 100f is prolonged, which may easily cause malfunction.

Thus, a rotation shown in FIG. 4 is executed. As shown in FIG. 4, in state 1, the hot water supplier 100a is designated as the main 1 hot water supplier, the hot water supplier 100b as the main 2 hot water supplier, and hot water suppliers 100c to 100f are designated as the sub hot water suppliers. Each of the hot water suppliers 100a to 100f sequentially calculates a cumulative value of their respective operating time (combustion time). In state 1, when the operating time (cumulative value) of the hot water supplier 100a reaches a predetermined time reference value, a rotation for transition from state 1 to state 2 is performed. In state 2, the designations of the main 1 hot water supplier and the main 2 hot water supplier are shifted one by one from the upstream side to the downstream side from state 1.

As a result, the hot water supplier 100b is designated as the main 1 hot water supplier, the hot water supplier 100c as the main 2 hot water supplier, and the hot water suppliers 100d to 100f and 100a are designated as the sub hot water suppliers. The hot water supplier 100a may be designated as the hot water supplier that starts supplying hot water the latest among the sub hot water suppliers. At this stage, the operating time (cumulative value) of the hot water supplier 100a, which is compared with the time reference value, may be cleared.

In state 2, when the operating time (cumulative value) of the hot water supplier 100b reaches a predetermined time reference value, a rotation for transition from state 2 to state 3 is performed. In state 3, the designations of the main 1 hot water supplier and the main 2 hot water supplier are shifted one by one from the upstream side to the downstream side from state 2.

As a result, the hot water supplier 100c is designated as the main 1 hot water supplier, the hot water supplier 100d as the main 2 hot water supplier, and the hot water suppliers 100e to 100f, 100a, and 100b are designated as the sub hot water suppliers. The hot water supplier 100b is treated in the same way as the hot water supplier 100a during the transition from state 1 to state 2.

After that, every time the operating time (cumulative value) of the hot water supplier designated as the main 1 hot water supplier reaches the time reference value, a rotation is executed in which the designations of the main 1 hot water supplier and the main 2 hot water supplier are shifted one by one from the upstream side to the downstream side. In a case where the hot water supplier 100f on the most downstream side is designated as the main 1 hot water supplier, the hot water supplier 100a on the most upstream side is designated as the main 2 hot water supplier, and after rotation is executed from this state, state 1 is formed again.

### (Decision of Role Allocation of Cooperative Control)

The supervisory function for cooperative control described in FIGS. 3 and 4, particularly the function of designating the main 1 hot water supplier, the main 2 hot water supplier, and the sub hot water suppliers, is achieved by: one controller 110 of the hot water suppliers 100a to 100f operates as a “leader controller” that executes an supervisory function program to realize the supervisory function, which is equivalent to the master controller in the Patent Literature 1. Moreover, the supervisory function of the leader controller includes a function of supplying hot water under independent control by its own device when there is no other hot water supplier communicatively connected downstream.

The controller 110 of each of the hot water suppliers 100a to 100f also stores programs for operating as the main 1 hot water supplier, the main 2 hot water supplier, and the sub hot water suppliers described in FIG. 3, respectively. Similarly, during execution of hot water supply operation, programs for operating as “for capacity adjustment” and “for capacity fix” are also stored in advance in the controller 110 of each of the hot water suppliers 100a to 100f, respectively. Thus, by selectively executing processing by these programs according to designations from the leader controller, each of the hot water suppliers 100a to 100f may execute any of the roles of the main 1 hot water supplier, the main 2 hot water supplier, and the sub hot water suppliers.

In the hot water supply system according to the embodiment, by storing the supervisory function program in the controller 110 of each of the hot water suppliers 100a to 100f and selectively performing the execution (activation), each controller 110 of the hot water suppliers 100a to 100f may operate as a leader controller. As a result, as in Patent Literature 1, cooperative control of the hot water suppliers 100a to 100f may be performed without arranging a higher-level supervisory controller.

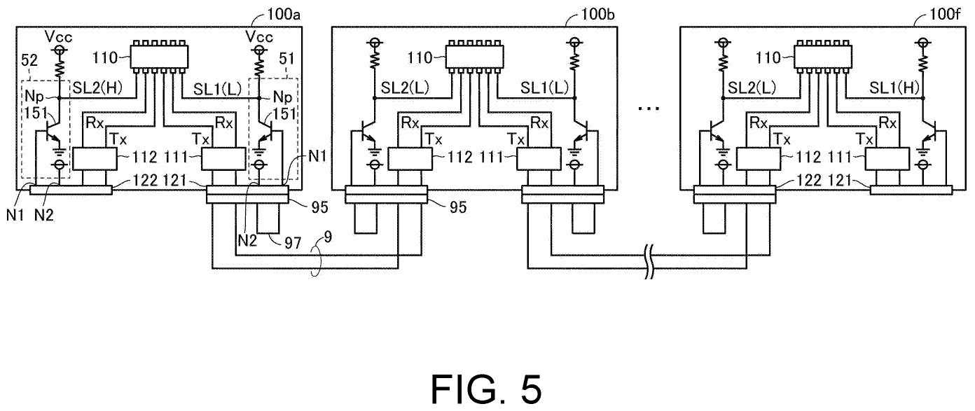

FIG. 5 shows a configuration example for detecting whether or not a communication line is connected to a communication connector in each hot water supplier.

As shown in FIG. 5, each hot water supplier 100 is provided with a first detection circuit 51 corresponding to the first communication connector 121 and a second detection circuit 52 corresponding to the second communication connector 122. Since the first detection circuit 51 and the second detection circuit 52 have the same configuration, the configuration of the first detection circuit 51 will be described. The first communication connector 121 and the second communication connector 122 correspond to a “first connector” and a “second connector”, respectively.

The first detection circuit 51 includes a transistor 151 electrically connected between a node Np and a ground (GND), a node N1 connected to a control electrode (base) of the transistor 151, and a node N2 to which a power supply voltage Vcc is input. The node Np is connected to a node to which the power supply voltage Vcc is input via a resistance element (pull-up resistor).

A cable connector 95 is provided at two ends of the communication line 9 for connection to the first communication connector 121 or the second communication connector 122 of the hot water supplier 100. The cable connector 95 is provided with a connection part of a shorting pin 97 for detecting the connection between the hot water supplier side and the communication line 9, in addition to a connection part of the communication line 9 with respect to the first communication circuit 111 or the second communication circuit 112. The shorting pin 97 may be realized, for example, by providing the cable connector 95 with a short electrical wire of about 1 to 2 cm.

Each of the first communication connector 121 and the second communication connector 122 may be a connector housing for multiple terminals, integrating the connection part of the communication line 9 and the connection part of the shorting pin 97 by a fitting structure with the cable connector 95. The connection and removal of the communication line 9 and the connection and removal of the shorting pin 97 may be reliably interlocked. That is, the shorting pin 97 corresponds to an example of a “short circuit terminal”.

When the shorting pin 97 is not connected to the first communication connector 121, the node N1 and the node N2 are opened, so the transistor 151 is maintained in an OFF state. At this time, a first detection signal SL1 generated at the node Np connected to the collector of the transistor 151 is set to H level (power supply voltage Vcc).

On the other hand, if the shorting pin 97 is connected to the first communication connector 121, in response to the short circuit between the nodes N1 and N2, the transistor 151 is turned ON according to the application of the power supply voltage Vcc to the control electrode. At this time, the first detection signal SL1 generated at the node Np changes from the H level (power supply voltage Vcc) to the L level (GND). Thus, the first detection signal SL1 is set to H level (corresponding to “first level”) when the communication line 9 (cable connector 95) is not connected to the first communication connector 121 (with no connection), while it is set to L level (corresponding to “second level”) when the communication line 9 (cable connector 95) is connected (with connection).

Also in the second detection circuit 52 corresponding to the second communication connector 122, a second detection signal SL2 generated at the node Np connected to the collector of the transistor 151 is set to L level when the communication line 9 (cable connector 95) is connected to the second communication connector 122 (with connection). On the other hand, it is set to H level when the communication line 9 (cable connector 95) is not connected (with no connection). The first detection signal SL1 and the second detection signal SL2 are input to the controller 110. Thus, based on the first detection signal SL1 and the second detection signal SL2, the controller 110 of each hot water supplier 100 is able to detect whether or not the communication line 9 (cable connector 95) is connected to each of the first communication connector 121 and the second communication connector 122.

FIG. 5 shows an aspect of communication connection in the configuration example of FIG. 1. In the hot water supplier 100a on the most upstream side, the communication line 9 is connected to the first communication connector 121, while the communication line 9 is not connected to the second communication connector 122. That is, in the hot water supplier 100a, only communication by the first communication circuit 111 is performed.

In the hot water supplier 100b, the communication line 9 (cable connector 95) is connected to both the first communication connector 121 and the second communication connector 122 (SL1=SL2=L level), and the second communication circuit 112 may transmit and receive data to and from the first communication circuit 111 of the upstream hot water supplier 100a via the communication line 9. In the hot water supplier 100b, communication is performed by both the first communication circuit 111 and the second communication circuit 112.

In the hot water supplier 100f on the most downstream side, the communication line 9 is connected to the second communication connector 122, while the communication line 9 (cable connector 95) is not connected to the first communication connector 121 (SL1=L level, SL2=H level). That is, in the hot water supplier 100f, only communication by the second communication circuit 112 is performed. The second communication circuit 112 may transmit and receive data with the first communication circuit 111 of the upstream hot water supplier (hot water supplier 100e) via the communication line 9.

Also in the hot water suppliers 100c to 100e (FIG. 1) connected between the hot water supplier 100b and the hot water supplier 100f, the communication line 9 (cable connector 95) is connected to both the first communication connector 121 and the second communication connector 122. The second communication circuit 112 transmits and receives data to and from the first communication circuit 111 of the upstream hot water supplier, and the first communication circuit 111 transmits and receives data to and from the second communication circuit 112 of the downstream hot water supplier. That is, similarly to the hot water supplier 100b, communication is performed by both the first communication circuit 111 and the second communication circuit 112.

In the hot water supply system according to this embodiment, as described below, whether or not the controller of each hot water supplier operates as a leader controller is automatically determined by the control processing through a signal indicating whether or not the communication line 9 (cable connector 95) is connected to the first communication connector 121 and the second communication connector 122, thereby role allocation of cooperative control is performed.

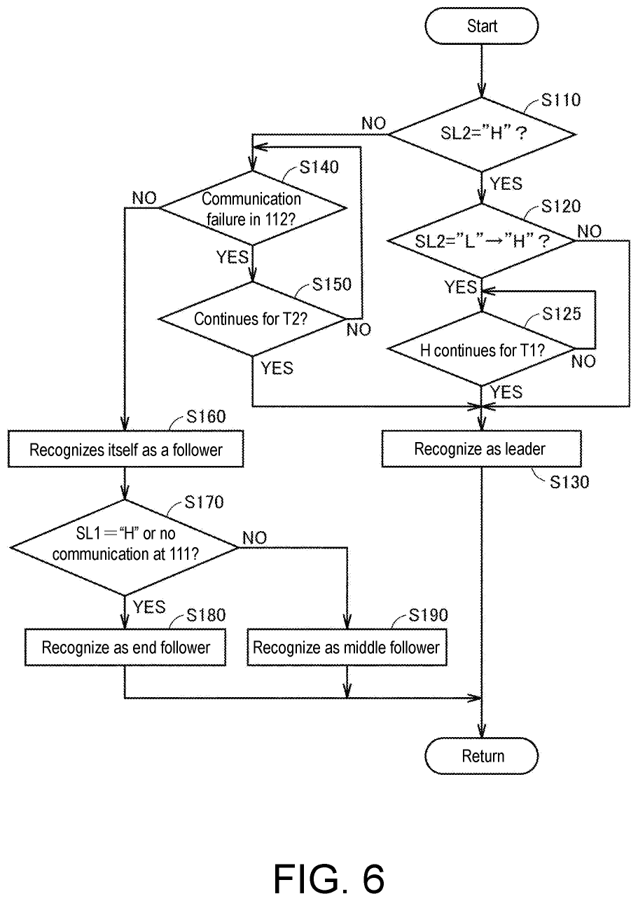

FIG. 6 shows a flowchart illustrating a control processing for deciding role allocation of cooperative control in the hot water supply system according to the embodiment. The control processing shown in FIG. 6 is repeatedly executed by each controller 110 of the hot water suppliers 100a to 100f while the hot water supply system 10 is in operation.

As shown in FIG. 6, the controller 110 determines whether or not the second detection signal SL2 is at the H level in step (hereinafter simply referred to as “S”) 110, and when it is at the H level (the determination in S110 is YES), it is determined in S120 whether or not SL2 has changed from the L level to the H level.

When the determination in S120 is NO and the state where the second detection signal SL2 is at H level, that is, the state where the communication line 9 (cable connector 95) is not connected to the second communication connector 122 has continues, the processing proceeds to S130.

When the second detection signal SL2 changes from the L level to the H level (when the determination in S120 is YES), the controller 110 determines whether or not the state of SL2=H level has continued for a predetermined time T1 (for example, about 2 to 3 seconds) in S125. When the controller 110 detects that the SL2=H level continues for the predetermined time T1 (when the determination in S125 is YES), the processing proceeds to S130. The predetermined time T1 is set to prevent false detection due to the influence of noise or the like. As a result, when the second detection signal SL2 remains at the H level for the predetermined time T1 or more, the processing proceeds to S130.

On the other hand, when the second detection signal SL2 is at the L level (determination in S110 is NO), the controller 110 determines whether or not the state of communication failure of the second communication circuit 112 has lasted for a predetermined time T2 (for example, about 2 to 3 minutes) in S140 and S150. That is, T2>T1. For example, whether or not there is a communication failure may be determined by whether or not there is an interruption in transmission from the first communication circuit 111 (hot water supplier on the upstream side), which is connected by the communication line 9 to the second communication circuit 112.

If the second communication circuit 112 continues to be in a communication failure state for the predetermined time T2 (when the determination S140 and S150 are YES), the controller 110 advances the processing to S130. The predetermined time T2 is also set to prevent false detection.

In S130, in response to the lack of communication by the second communication circuit 112 to communicate with the upstream hot water supplier due to the non-connection of the cable connector 95 or the communication failure of the communication line 9, the controller 110 recognizes that its own device is the “leader hot water supplier”. At this time, when the cable connector 95 (communication line 9) is not connected to the second communication connector 122, it is possible to recognize the hot water supplier as a “leader hot water supplier” as an early stage without having to wait for the state of no communication to continue for the predetermined time T2. Moreover, as described above, the leader hot water supplier may supply hot water under its own independent control when there is no other hot water supplier communicatively connected downstream.

When the determination in S140 is NO, that is, when the communication failure by the second communication circuit 112 while the communication line 9 is connected to the second communication connector 122 is not detected, the controller 110 recognizes in S160 that itself is a “follower controller” installed on a “follower hot water supplier” that operates cooperatively according to a command from the leader hot water supplier (e.g., designation of rotation described in FIG. 4).

Further, depending on presence or absence of communication in the first communication circuit 111, the controller 110 may determine whether its own device is an “end follower” positioned at the most downstream of the communication connection or a “middle follower” positioned in the middle in S170. For example, according to the confirmation of whether the communication line 9 (cable connector 95) is connected to the first communication connector 121 based on the first detection signal SL1, and of the communication state (presence or absence of communication) by the second communication circuit 112, in a case where SL1=H level has continued for the predetermined time T1, or when communication by the first communication circuit 111 it not performed continuously for the predetermined time T2, YES is determined in S170. At this time, the controller 110 determines that communication by the first communication circuit 111 is not performed, and recognizes that its own device is the “end follower hot water supplier” in S180.

On the other hand, when SL1=L level and the communication line 9 (cable connector 95) is connected to the first communication connector 121, or when communication by the first communication circuit 111 is being performed, No is determined in S170, and the processing proceeds to S190. In S190, the controller 110 recognizes that its own device is a “middle follower hot water supplier.”

By periodically activating the processing shown in FIG. 6, each of the hot water suppliers 100a to 100f communicatively connected in series is able to automatically decide its own device as operating which one of: a “leader hot water supplier”, a “middle follower hot water supplier”, and “end follower hot water supplier”, that is, decide the role allocation in cooperative control.

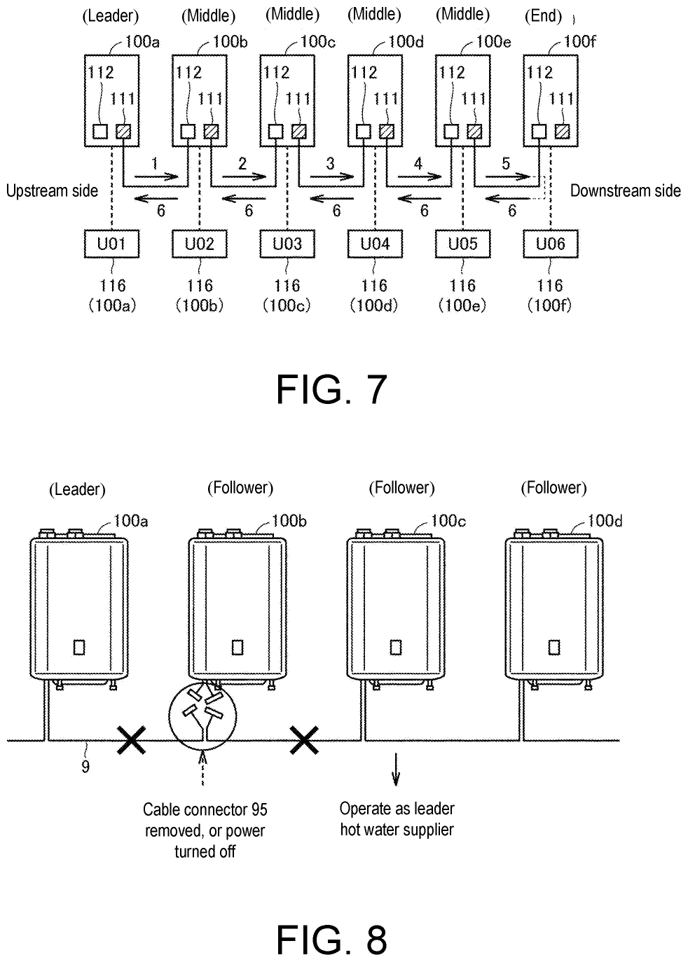

FIG. 7 shows a result of deciding the allocation of cooperative control when the control processing according to the flowchart of FIG. 6 is applied to the configuration example of FIG. 1.

Referring to FIG. 7, in the hot water supplier 100a of the most upstream side where the communication line 9 (cable connector 95) is not connected to the second communication connector 122, it is recognized as a leader hot water supplier (S130) when SL2=H level continues for the predetermined time T1 or more.

Further, in the hot water supplier 100f where the communication line 9 (cable connector 95) is not connected to the first communication connector 121 (SL1=H), it is recognized as “end following hot water supplier” (S180) when YES is determined in S170 after the determination of NO in S110.

Similarly, for each of the hot water suppliers 100b to 100e communicating with the upstream and downstream hot water suppliers, after the determination of NO in S110, No is determined in S140 and S170, thereby it is recognized as being a “middle follower hot water supplier” (S140).

For example, the controller 110 installed in the leader hot water supplier (hot water supplier 100a) may assign an address to each hot water supplier in the group of hot water suppliers and obtain the total number of hot water suppliers by using the address counter value sequentially transmitted to the downstream side with a count up in a group of hot water suppliers communicatively connected in series, i.e. a group of hot water suppliers that performs cooperative control.

Specifically, as shown in FIG. 7, the hot water supplier 100a (leader hot water supplier) transmits an address counter value set to an initial value “1” to the downstream hot water supplier 100b. The hot water supplier 100b transmits a value obtained by adding “1” to the address counter value received from the upstream hot water supplier 100a to the downstream hot water supplier 100c. As a result, an address counter value set to “2” is transmitted from the hot water supplier 100b to the hot water supplier 100c. Hereinafter, similar to the hot water supplier 100b, each of the hot water suppliers 100c to 100e, which are middle follower hot water suppliers among the follower hot water suppliers, transmits a value obtained by adding “1” to the address counter value received from the upstream hot water supplier to the downstream hot water supplier 100. The hot water supplier 100f, which is the end follower hot water supplier among the follower hot water suppliers, transmits a value obtained by adding “1” to the address counter value received from the upstream hot water supplier to the upstream hot water supplier 100e.

As a result, the address counter values transmitted from the hot water suppliers 100a to 100f become “1” to “6” in the order of the daisy chain. Thus, each of the hot water suppliers 100a to 100f may recognize the address counter value transmitted by itself as its own address. Further, the address counter value transmitted from the hot water supplier 100f, which is the end follower hot water supplier, corresponds to the number of connections of the daisy chain, i.e., the total number of hot water suppliers for cooperative control.

Each of the hot water suppliers 100b to 100e sequentially transmits the address counter value received from the hot water supplier on the downstream side to the hot water supplier on the upstream side with the value as it is without adding. Thereby, the hot water supplier 100a can obtain the above-mentioned total number of hot water suppliers by receiving the address counter value transmitted from the hot water supplier 100f.

In the following, thus, the leader hot water supplier (hot water supplier 100a) may manage cooperative control by rotating the roles of the main hot water supplier 1, the main hot water supplier 2, and four sub hot water suppliers with respect to the hot water suppliers having addresses of “1” to “6”.

Moreover, each of the hot water suppliers 100a to 100f may be configured to include a display part 116 such as a segment display of an LED (Light Emitting Diode). In this case, the display part 116 may display address of its own device recognized by each hot water supplier as its own for a certain period of time in response to the above-described transmission and reception of the address counter value. Thereby, workers and the like can easily confirm whether or not the address has been correctly assigned.

(Processing when Communication Line is Removed)

Next, a description will be given of cooperative control processing when one of the hot water suppliers is temporarily out of use due to inspection or maintenance.

FIG. 8 shows a comparative example of cooperative control processing when one hot water supplier is temporarily not used. In FIG. 8, as a comparative example, control processing not including S110 to S130 in FIG. 6 is executed.

As shown in FIG. 8, assume that in the hot water supply system 10, the hot water supplier 100b is temporarily disused for reasons such as inspection or maintenance. In this case, the communication line 9 is removed from the first communication connector 121 and the second communication connector 122 (FIG. 2) of the hot water supplier 100b. Alternatively, the hot water supplier 100b is powered off.

Accordingly, communication between the hot water supplier 100b and the hot water supplier 100a and communication between the hot water supplier 100b and the hot water supplier 100c are no longer performed. In this way, since the hot water supplier 100a no longer has a hot water supplier in communication connection with itself, it operates independently to continue supplying hot water. On the other hand, by the determination of YES in S140 and S150 of FIG. 6 (S130), the hot water supplier 100c is able to recognize itself as the leader hot water supplier. Accordingly, the controller 110 installed in the hot water supplier 100c, which has been operating as a follower controller, now operates as a leader controller, assigning addresses and obtaining the total number as described in FIG. 7, thereby hot water may be supplied by the hot water suppliers 100c to 100f (four) operating cooperatively.

However, as described above, the hot water supplier 100c cannot operate as the leader hot water supplier until the predetermined time T2 for preventing false detection has elapsed. During this period, there is no leader hot water supplier among the hot water suppliers 100c to 100f and hot water cannot be supplied from these hot water suppliers, so only the hot water supplier 100a is used to supply hot water. As a result, there is a possibility that the flow rate of hot water supplied by the hot water supply system may decrease temporarily (for example, for about several minutes).

In contrast, in the hot water supply system according to the embodiment, the processing of S110 to S130 in FIG. 6 are executed. Thus, the hot water supplier on the downstream side of the hot water supplier that is temporarily unused may quickly operate as the leader hot water supplier.

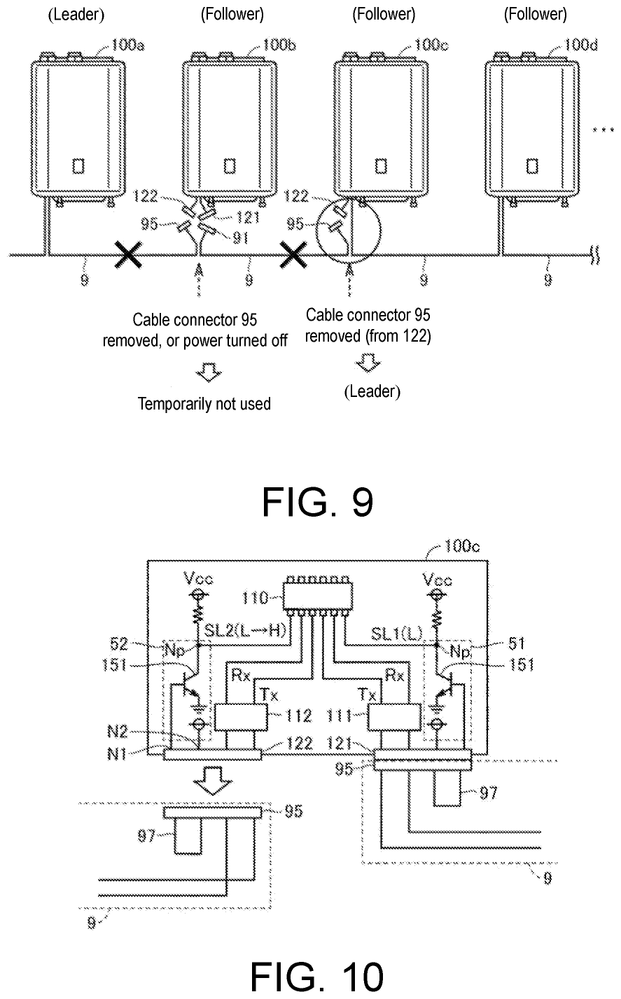

Referring to FIG. 9, in the hot water supply system 10 according to the embodiment, similarly to FIG. 8, in addition to removing the communication line 9 by the cable connector 95 or turning off power in the hot water supplier 100b that is temporarily unused, the communication line 9 is removed from the second communication connector 122 configured to communicate with the upstream hot water supplier 100b in the hot water supplier 100c downstream of the hot water supplier 100b.

FIG. 10 is a schematic diagram illustrating the state inside the hot water supplier 100c with the cable connector 95 removed from the connector.

As shown in FIG. 10, before the cable connector 95 connecting with the hot water supplier 100b is removed from the second communication connector 122, the second detection signal SL2 by the second detection circuit 52 is set to L level. The first detection signal SL1 by the first detection circuit 51 is also set to L level because the cable connector 95 that connects the hot water supplier 100e is connected to the first communication connector 121.

When the cable connector 95 is removed from the second communication connector 122, the second detection signal SL2 changes from L level to H level in the second detection circuit 52 in response to the transistor 151 being turned off.

Accordingly, through the processes of S110 to S130 in FIG. 6, the hot water supplier 100c may operate as a leader hot water supplier when the predetermined time T1 (T1<T2) has elapsed.

Thus, according to this embodiment, in the hot water supply system 10 in which multiple hot water suppliers are communicatively connected in series via the communication line 9, cooperative control that automatically and promptly responds to the removal of the communication line 9 by the cable connector 95 can be realized. As a result, compared to the comparative example in FIG. 8, the period during which hot water cannot be supplied by the hot water suppliers 100c to 100f is significantly shortened, such that it is possible to suppress a temporary decrease in the flow rate of hot water supplied by the hot water supply system.

Moreover, in FIG. 7, an example in which after being initialized in the leader hot water supplier, an address counter value that changes each time by a specified value (for example, counted up each time by 1) is sequentially transmitted to the middle follower hot water supplier and the end follower hot water supplier in turn, and the value is then transferred without change to the leader hot water supplier after the end follower hot water supplier counts up, but instead of such a “counter value”, the same effect can be achieved by a manner in which arbitrary data is sequentially changed according to a predetermined rule, and sequentially transmitted to the middle follower hot water suppliers and the end follower hot water supplier, that is, assigning address to each hot water supplier and obtaining the number of connected suppliers in the daisy-chained connection.

The embodiments disclosed this time should be considered to be illustrative in all respects and not restrictive. The scope of the disclosure is indicated by the claims rather than the above description, and it is intended that all changes within the meaning and range equivalent to the claims are included.

What is claimed is:

1. A hot water supply system, comprising:
a plurality of hot water suppliers connected in parallel to a common hot water outlet route,
wherein each of the plurality of hot water suppliers comprises:
a first connector and a second connector connectable to a communication line and a short circuit terminal;
a first communication circuit for communicating with another hot water supplier via the communication line connected to the first connector;
a second communication circuit for communicating with another hot water supplier via the communication line connected to the second connector;
a first detection circuit that detects whether or not the communication line is connected to the first connector based on whether or not the short circuit terminal is connected to the first connector;
a second detection circuit that detects whether or not the communication line is connected to the second connector based on whether or not the short circuit terminal is connected to the second connector; and
a controller that controls operation of the hot water supplier,
wherein the controller of each of the hot water suppliers is configured in advance to have a supervisory control function for cooperatively operating a group of hot water suppliers communicatively connected in series via the communication line,
between adjacent hot water suppliers in a series connection constituting the communication connection, the first communication circuit of a hot water supplier on an upstream side, which is one predetermined end of the series connection, and the second communication circuit of a hot water supplier on a downstream side, which is the other end of the series connection, in the group of hot water suppliers are communicatively connected sequentially, and
each of the controllers:
recognizes that the controller is a leader controller that operates to perform the supervisory control when it is detected by the first detection circuit that the communication line is connected to the first connector and it is detected by the second detection circuit that the communication line is not connected to the second connector.

2. The hot water supply system according to claim 1,
wherein each of the controllers recognizes that the controller is a follower controller that operates cooperatively in response to a command from the leader controller when it is detected by the second detection circuit that the communication line is connected to the second connector.

3. The hot water supply system according to claim 2,
wherein
when it is detected by the second detection circuit that after a change from a state in which the communication line is connected to the second connector to a state in which the communication line is not connected to the second connector, the state in which the communication line is not connected has continued for a first predetermined time, or
in a case where the state in which the communication line is connected to the second connector is detected by the second detection circuit, when a communication failure by the second communication circuit has continued for a second predetermined time longer than the first predetermined time,
the controller operating as the follower controller operates by switching a role from the follower controller to the leader controller.

4. The hot water supply system according to claim 1,
wherein
in a case where a state in which the communication line is connected to the second connector is detected by the second detection circuit, when a communication failure by the second communication circuit has continued for a first predetermined time, or
when a state in which the communication line is not connected to the second connector has continued for a second predetermined time period or longer, which is shorter than the first predetermined time, is detected by the second detection circuit
each of the controllers recognizes that the controller is the leader controller.

5. The hot water supply system according to claim 1,
wherein each of the first connector and the second connector comprises a connector housing for a plurality of terminals for integrally connecting the communication line and the short circuit terminal.

6. The hot water supply system according to claim 2,
wherein each of the first connector and the second connector comprises a connector housing for a plurality of terminals for integrally connecting the communication line and the short circuit terminal.

7. The hot water supply system according to claim 3, wherein each of the first connector and the second connector comprises a connector housing for a plurality of terminals for integrally connecting the communication line and the short circuit terminal.

8. The hot water supply system according to claim 4,
wherein each of the first connector and the second connector comprises a connector housing for a plurality of terminals for integrally connecting the communication line and the short circuit terminal.

9. The hot water supply system according to claim 1,
wherein each of the first detection circuit and the second detection circuit is configured such that:
a detection signal of a first level is output in response to an opening between a first node and a second node when the short circuit terminal is not connected to the first connector or the second connector; and the detection signal of a second level is output in response to a short circuit between the first node and the second node when the short circuit terminal is connected to the first connector or the second connector.

10. The hot water supply system according to claim 2,
wherein each of the first detection circuit and the second detection circuit is configured such that:
a detection signal of a first level is output in response to an opening between a first node and a second node when the short circuit terminal is not connected to the first connector or the second connector; and the detection signal of a second level is output in response to a short circuit between the first node and the second node when the short circuit terminal is connected to the first connector or the second connector.

11. The hot water supply system according to claim 3,
wherein each of the first detection circuit and the second detection circuit is configured such that:
a detection signal of a first level is output in response to an opening between a first node and a second node when the short circuit terminal is not connected to the first connector or the second connector; and the detection signal of a second level is output in response to a short circuit between the first node and the second node when the short circuit terminal is connected to the first connector or the second connector.

12. The hot water supply system according to claim 4,
wherein each of the first detection circuit and the second detection circuit is configured such that:
a detection signal of a first level is output in response to an opening between a first node and a second node when the short circuit terminal is not connected to the first connector or the second connector; and the detection signal of a second level is output in response to a short circuit between the first node and the second node when the short circuit terminal is connected to the first connector or the second connector.

13. The hot water supply system according to claim 1, wherein the supervisory control comprises a rotation processing in the group of hot water suppliers of designating an operation start sequential order in response to an increase in a hot water supply flow rate.

14. The hot water supply system according to claim 2, wherein the supervisory control comprises a rotation processing in the group of hot water suppliers of designating an operation start sequential order in response to an increase in a hot water supply flow rate.

15. The hot water supply system according to claim 3, wherein the supervisory control comprises a rotation processing in the group of hot water suppliers of designating an operation start sequential order in response to an increase in a hot water supply flow rate.

16. The hot water supply system according to claim 4, wherein the supervisory control comprises a rotation processing in the group of hot water suppliers of designating an operation start sequential order in response to an increase in a hot water supply flow rate.
